(19) United States
(12) Patent Application Publication
(10) Pub. No.: US 2025/0162376 A1
(43) Pub. Date: May 22, 2025

(54) PORTABLE MOTORSPORTS PERSONAL EVAPORATIVE COOLER

(71) Applicant: MARION LEE CHATMAN, STONE MOUNTAIN, GA (US)

(72) Inventor: MARION LEE CHATMAN, STONE MOUNTAIN, GA (US)

(21) Appl. No.: 18/514,323

(22) Filed: Nov. 20, 2023

(51) Int. Cl. B60H 1/00

(52) U.S. Cl. CPC B60H 1/00035; B60H 1/00028; B60H 1/00278

(57) ABSTRACT

The present invention is an integrated, highly-portable, mountable, high-air-volume air-cooler with integrated evaporative mister for personal cooling. More specifically, the invention is a high volume, low-power-draw, integrated air personal cooler and evaporative mister that can be easily mounted and connected to the electrical system of a motorcycle, all-terrain vehicle or other open-air motorsports vehicle to provide effective and flexible personal cooling for the rider/driver and passengers and a highly-effective, lightweight, attractive and well-packaged alternative to other personal cooling and air-conditioning systems.

CROSS-REFERENCE: U.S. PROVISIONAL PATENT APPLICATION No. 63/427,955 FILED 11/25/2022

### BACKGROUND

### Field of the Invention

The present invention relates to fan and evaporative cooling systems. More specifically, the present invention relates to portable and vehicle-mounted personal cooling and air-conditioning systems.

### Description of the Related Art

Current methods of providing highly-portable, mountable and low-power personal cooling or air conditioning device for motorcycles, all-terrain and other motorsports vehicles is generally limited to using a fan that is mountable on the handlebars of a motorcycle, an all-terrain vehicle, or a utility task vehicle (US20160068045A1); a fluid misting apparatus integrated into the motorcycle (U.S. Pat. No. 7,458,528B2); a thermoelectric cooler utilizing a fan and thermoelectric/peltier device and fluid for heat exchange (US20160068046A1); a compressor-based air-conditioning unit utilizing an external generator for power (U.S. Pat. No. 6,272,873B1); self-contained compressor-based units (WO2017149959A1); portable and body/fairing integrated air-over ice systems (U.S. Pat. No. 6,401,483B1) and auxiliary evaporative cooling units using power-take off or other vehicle power drive (U.S. Pat. No. 5,168,722A). However none of the prior art for the above personal cooling systems covers for high volume air movement with low power consumption, combined with highly-portable packaging for re-use across multiple vehicles, easy integration into common vehicle power systems and the potential ability to accommodate a variety of personal protective gear or employed and riding/driving situations commonly encountered by riders/drivers and passengers.

### SUMMARY

It is the primary object of the invention to provide vastly more effective and better-packaged personal cooling for the drivers and passengers of motorcycles, ATVs and other open-air motorsports vehicles.

It is the secondary object of the invention to provide a platform that can accommodate a variety of personal protective gear employed and riding/driving situations commonly encountered by riders/drivers and passengers.

### BRIEF DESCRIPTION OF THE DRAWINGS

Briefly FIG. 1 is a prospective view illustrating the present invention attached to a motorcycle with rider mounted and direction of in and out airflow from the device indicated with line-arrows.

FIG. 2 is a close-up view of the assembled unit including enclosing bag, mounting straps, power switch and timer adjustment panel

FIG. 3 is a top-down semi-transparent view of the interior components including blower unit, attached duct and screen, water storage, electric water pump, water hose leading to blower exhaust side and attached mister wand, power switch and power cables, pump timer unit and connected timer adjustment panel

FIG. 4 is a side semi-transparent view of the opened bag including the platform and water hose leading to blower exhaust side and attached sprinkler.

FIG. 5 is a prospective view illustrating the present invention with the air duct collapsed into the interior of the bag and the bag closed.

### DETAILED DESCRIPTION

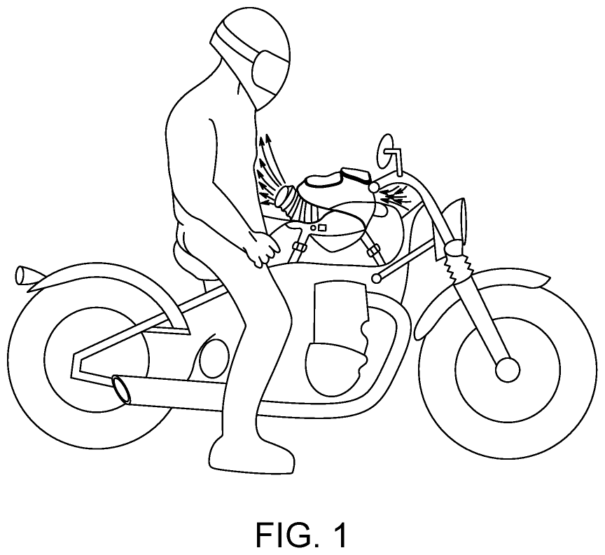

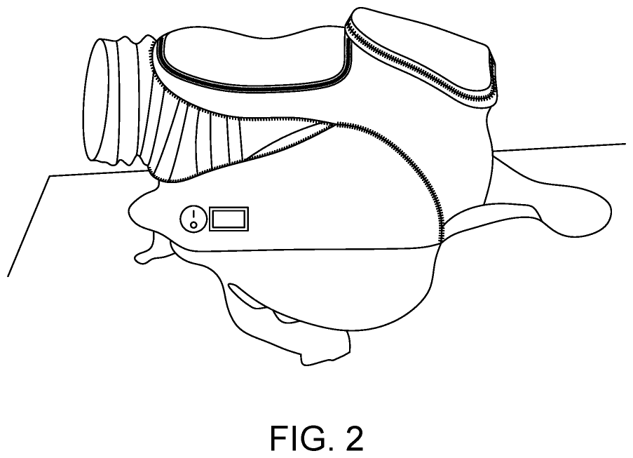

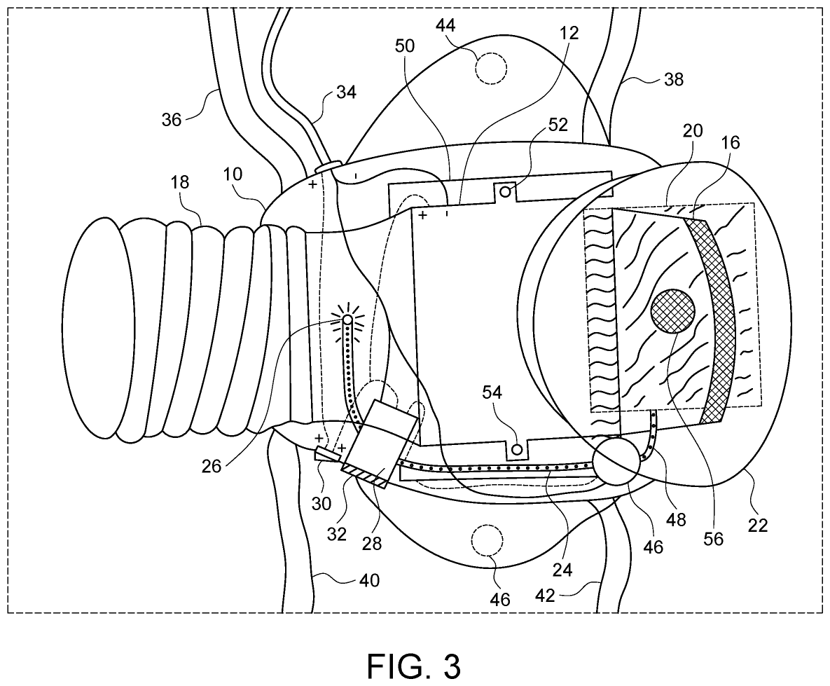

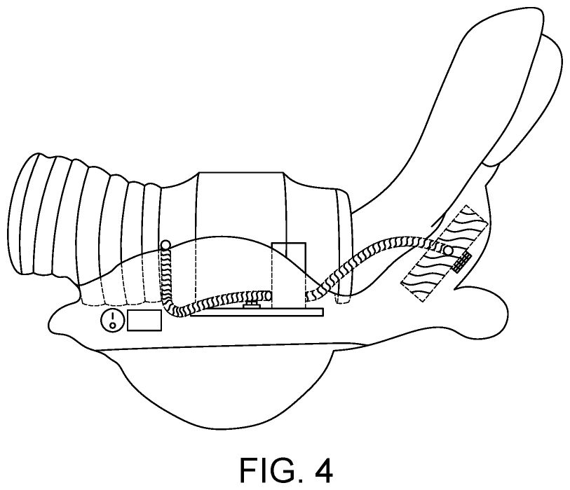

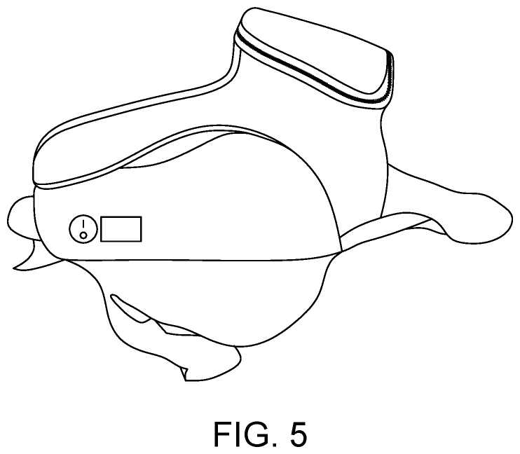

FIGS. 1-4 of the preferred embodiment illustrate the personal cooling unit attached to a motorcycle)FIG. 1) the basic internal components including a bag (10, 22) containing a blower unit mounted to a base plate with fasteners (50, 52, 54) used to supply a high-volume (200 cfm or more) of fresh air to the rider/driver/passenger (12), the attached collapsible/adjustable duct used to direct air to the rider (18). The duct can be collapsed into the interior of the bag and the bag fully closed front and/or back when not in use (FIG. 5). A screen mounted on the intake prevents debris from being sucked into the unit or blown onto the rider (16). A water pump (46) provides water via a tube (24, 48) from a refillable water container with cap (20, 56) to a mister wand (26) in the path of the output airflow from the blower to provide additional evaporative cooling to the rider (20). A master power switch (30) turns the blower and mister unit on or off. An adjustment panel with display and buttons (32) directs the adjustable relay timer (28) to trigger the frequency and duration of the water pump activation that supplies water to the mister wand (26) or to switch the mister off independently. The unit receives power positive and ground from cable connection (34) to the vehicle power port or directly to vehicle battery. The unit can be fully disconnected from the vehicle and moved to a different vehicle as needed being attached with attached straps (36, 38, 40, 42) and/or other means such as magnets embedded in the bag (44, 46).

Another embodiment of this invention is to replace the mister spray assembly in the output airflow with a moisture absorbing material that absorbs water directly from the water supply via siphon action from a tube or reservoir without a pump or with a supply tube from the water pump.

Another embodiment of this invention is to consolidate the master power switch, relay, timer and associated controls onto a single integrated circuit board assembly.

Another embodiment of this invention is to sterilize the fluid/water tank and contents with an ultraviolet light source.

Another embodiment of this invention is to utilize an ionic air mover instead of a conventional blower.

Another embodiment of this invention is to incorporate a bluetooth and/or wireless receiver allowing for power and mister duration and timing control from a bluetooth or wireless control device.

Another embodiment of this invention is to incorporate an on-board rechargeable battery to supply unit power when not connected to the vehicle power supply

Another embodiment of this invention is to incorporate a solar power array and solar charge controller to supply unit and battery recharge power when not connected to the vehicle power supply

Another embodiment of this invention is to incorporate multiple blower/mister assemblies into a larger hard-sided or soft-sided bag with water supply to supply multiple streams of air to driver and several passengers

Another embodiment of this invention is a smaller bag with a reduced size blower/mister/water/battery that can straddle the top-tube of the bicycle or other human-powered device and provide cooling to the rider

Another embodiment of this invention substitutes the flexible duct with a pipe and/or adjustable vent/register to direct the air

Another embodiment of this invention is to mount the blower/mister/battery/water supply into a backpack that can be carried and used by a person either on foot or in a vehicle

Another embodiment of this invention is to incorporate additional bag pockets to carry or store tools or cargo along with the unit

Another embodiment of this invention is to incorporate hook, strap, velcro or zipper attachable bags to carry tools or cargo similar to a motorcycle cargo bag

Another embodiment of this invention is to incorporate a detachable phone case and integrated charger on the bag

Another embodiment of this invention is to incorporate additional power and device ports, such as USB or ANSI power, into the bag

1) A highly-portable and mountable, high air volume, low power consumption, integrated air cooler and evaporative mister that can be easily mounted and connected to the body and electrical power system of a motorcycle, all-terrain vehicle side-by-side or other open-air motorsports vehicle to provide effective personal cooling for the rider/driver and/or passengers and a highly-effective, lightweight, attractive, and well-packaged alternative to other air-conditioning systems comprising:
a. a blower unit used to supply a high-volume (200 cfm or more) of fresh air to the rider/driver/passenger;
b. an adjustable vent, duct or register attached to the blower output used to direct airflow to the rider/driver/passenger;
c. an automatic means to deliver onboard evaporative water/fluid to the path of the exhaust airflow to provide evaporative cooling effect;
d. a master power switch that turns the blower and mister unit on or off;
e. a removable/swappable power cable for connection for power and ground to an available vehicle power port, and/or directly to the vehicle battery, and/or an internal rechargeable battery;
f. a containing bag that can be fully disconnected from the vehicle and moved to a different vehicle as needed, being attached with attached straps and/or other means such as magnets embedded in the bag.
